(19) United States
(12) Patent Application Publication
(10) Pub. No.: US 2022/0308009 A1
(43) Pub. Date: Sep. 29, 2022

(54) GAS SENSOR

(71) Applicant: NGK Insulators, Ltd., Nagoya-shi (JP)

(72) Inventors: Hiroki ADACHI, Nagoya-shi (JP); Kota KATAGIRI, Nagoya-shi (JP)

(21) Appl. No.: 17/699,745

(22) Filed: Mar. 21, 2022

(30) Foreign Application Priority Data
Mar. 24, 2021 (JP) 2021-049383

(51) Int. Cl. G01N 27/407

(52) U.S. Cl. CPC G01N 27/4078

(57) ABSTRACT

Provided is a gas sensor capable of realizing a stable crimped shape even when the crimp portion of the housing is pressed from above during manufacture. The gas sensor includes a sensor element, a holding member, and a housing. The sensor element is used to measure the concentration of a predetermined gas component in measurement target gas. The holding member holds part of the sensor element. The housing accommodates the sensor element and the holding member. The housing includes a tubular main body and a tubular crimp portion. The crimp portion is located closer to a rear end than the main body is, and presses, in a bent state, a rear end of the holding member. A cutout is formed in part of the crimp portion in a circumferential direction.

### CROSS-REFERENCE TO RELATED APPLICATION

The present application claims priority from Japanese application JP2021-049383, filed on Mar. 24, 2021, the contents of which is hereby incorporated by reference into this application.

### TECHNICAL FIELD

The present invention relates to a gas sensor.

### BACKGROUND ART

Japanese Patent No. 3885781 discloses a gas sensor. In this gas sensor, a sensor element is accommodated in a tubular housing. In this gas sensor, the housing and the sensor element are fixed to each other through crimping by bending a tubular fixing portion formed at a rear end of the housing.

Japanese Patent No. 3885781 is an example of related art.

According to the gas sensor as disclosed in Japanese Patent No. 3885781, the housing and the sensor element are fixed to each other through crimping by pressing the tubular fixing portion from above. However, in this gas sensor, the strength of a tubular reduced diameter portion of the tubular fixing portion may be insufficient. As a result, a stable crimped shape may not be realized.

The present invention was made in order to solve the above-described problems, and it is an object thereof to provide a gas sensor capable of realizing a stable crimped shape even when the crimp portion of the housing is pressed from above during manufacture.

### SUMMARY OF THE INVENTION

The present invention is directed to a gas sensor including a sensor element, a holding member, and a housing. The sensor element is used to measure the concentration of a predetermined gas component in measurement target gas. The holding member holds part of the sensor element. The housing accommodates the sensor element and the holding member. The housing includes a tubular main body and a tubular crimp portion. The crimp portion is located closer to a rear end than the main body is, and presses, in a bent state, a rear end of the holding member. A cutout is formed in part of the crimp portion in the circumferential direction.

A case will be considered in which no cutout is formed in part of the crimp portion in the circumferential direction. In this case, when the crimp portion is crimped, the rear end of the crimp portion is pushed inward in the radial direction, and thus the circumferential length of the rear end of the crimp portion decreases. As a result, an excess part of the bent portion of the crimp portion is forced outward in the radial direction, and thus, for example, lateral bulging of the crimp portion occurs. In this gas sensor, a cutout is formed in part of the crimp portion in the circumferential direction. Accordingly, even when the crimp portion is crimped and the rear end of the crimp portion is pushed inward in the radial direction, the bent portion is likely to be accommodated inside the radial direction compared with the case in which no cutout is formed. As a result, with this gas sensor, part of the crimp portion is unlikely to be forced outward in the radial direction even when the crimp portion is crimped, and thus lateral bulging of the crimp portion is unlikely to occur.

In the above-described gas sensor, a proportion of a length of the cutout in an outer circumference of the crimp portion with respect to a total length of the outer circumference of the crimp portion may be 0.3 or more.

In the above-described gas sensor, a proportion of a length of the cutout in an outer circumference of the crimp portion with respect to a total length of the outer circumference of the crimp portion may be 0.25 or more and 0.45 or less.

In the above-described gas sensor, the number of cutouts formed in the crimp portion may be four or more and six or less.

In the above-described gas sensor, a length from a position corresponding to a rear end of the crimp portion to a bottom of the cutout may be 2.00 mm or more and 3.00 mm or less.

In the above-described gas sensor, a plate thickness of the crimp portion may be 0.45 mm or more and 0.65 mm or less.

According to the present invention, it is possible to provide a gas sensor capable of realizing a stable crimped shape even when the crimp portion of the housing is pressed from above during manufacture.

### BRIEF DESCRIPTION OF THE DRAWINGS

FIG. 1 is a view schematically showing a vertical cross-section of part of a gas sensor.

FIG. 2 is a cross-sectional schematic view schematically showing an example of the configuration of a sensor element.

FIG. 3 is a view schematically showing a vertical cross-section of a housing before a crimp portion is crimped.

FIG. 4 is a view schematically showing a state of part of the crimp portion as viewed from a side.

FIG. 5 is a view schematically showing a cross-section taken along V-V in FIG. 3.

FIG. 6 is a schematic view showing a state in which the crimp portion is crimped as viewed from the rear.

FIG. 7 is a cross-sectional schematic view schematically showing an example of the configuration of a sensor element with a three-cavity structure.

FIG. 8 is a view corresponding to FIG. 5 according to a modified example.

FIG. 9 is a schematic explanatory view of a leak test using a test tool.

FIG. 10 is a view showing an example of the crimped shape according to Comparative Example 1.

FIG. 11 is a view showing an example of the crimped shape according to Example 1.

### EMBODIMENT OF THE INVENTION

Hereinafter, an embodiment of the present invention will be described in detail with reference to the drawings. Note that the same or corresponding constituent elements in the drawings are denoted by the same reference numerals and a description thereof will not be repeated.

### 1. Overall Configuration of Gas Sensor

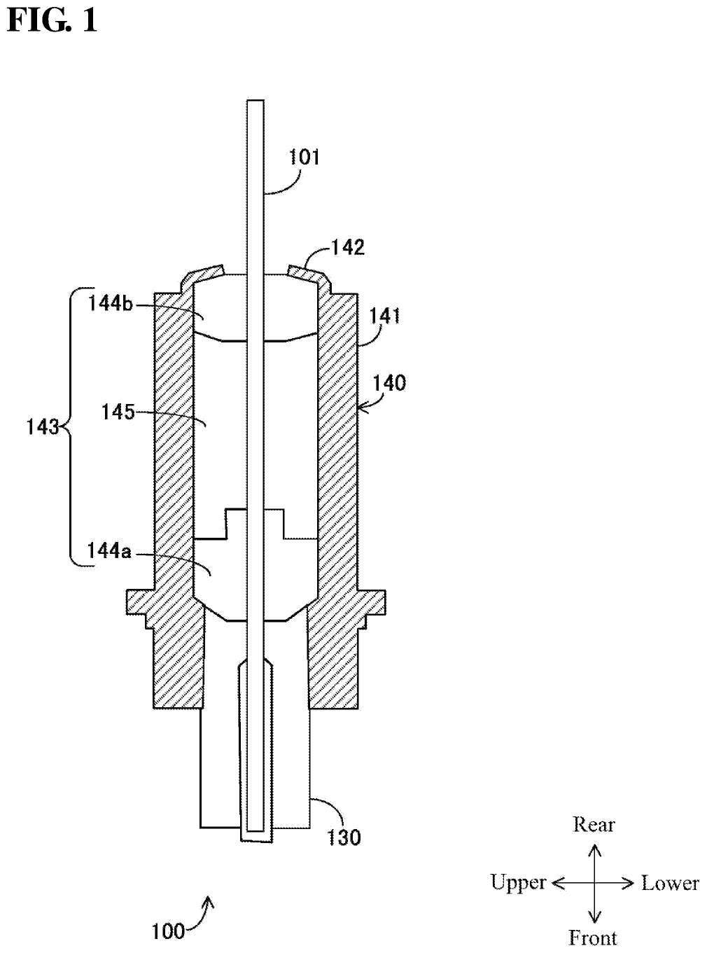

FIG. 1 is a view schematically showing a vertical cross-section of part of a gas sensor 100 according to this embodiment. In the drawings, the longitudinal direction of a later-described sensor element 101 corresponds to the front-rear direction, and the thickness direction of the sensor element 101 corresponds to the upper-lower direction.

As shown in FIG. 1, for example, the gas sensor 100 is attached to a pipe such as an exhaust gas pipe of a vehicle. The gas sensor 100 is configured to measure the concentration of a predetermined gas component in a measurement target gas such as exhaust gas. Examples of the predetermined gas component include NOx and O₂. Note that the gas sensor 100 according to this embodiment is configured to measure the NOx concentration in the measurement target gas.

The gas sensor 100 includes a sensor element 101, a protective cover 130, a holding member 143, and a housing 140. The sensor element 101 has an elongated cuboid shape, and is used to detect a predetermined gas component in a measurement target gas. The sensor element 101 will be described later in detail. The protective cover 130 has a tubular shape, and is configured to cover a portion in the vicinity of the front end of the sensor element 101.

The holding member 143 includes ceramic supporters 144a and 144b and a green compact 145. Each of the ceramic supporters 144a and 144b and the green compact 145 surrounds the sensor element 101 and holds the sensor element 101 inside the housing 140.

The housing 140 is made of a metal and includes a tubular main body 141 and a tubular crimp portion 142. Each of the ceramic supporters 144a and 144b and the green compact 145 is sealed inside the main body 141. In the housing 140, the inner diameter on the front end side is smaller than that at the rear end. The front end of the ceramic supporter 144a is engaged with an circumferential face of a portion with a smaller inner diameter in the housing 140. Accordingly, the holding member 143 is prevented from coming off the front side of the housing 140.

The sensor element 101 is positioned along the central axis of the holding member 143 and the housing 140, and extends through the holding member 143 and the housing 140 in the front-rear direction.

The crimp portion 142 is located closer to the rear end than the main body 141 is, and presses, in a bent state, the rear end of the holding member 143 (the ceramic supporter 144b). The crimp portion 142 is formed around the entire circumference in the circumferential direction. The crimp portion 142 is bent through crimping performed from above (the rear direction in the drawing). Accordingly, the holding member 143 is fixed inside the housing 140. The crimp portion 142 has a thickness smaller than that of the main body 141. The crimp portion 142 will be described later in detail.

### 2. Configuration of Sensor Element

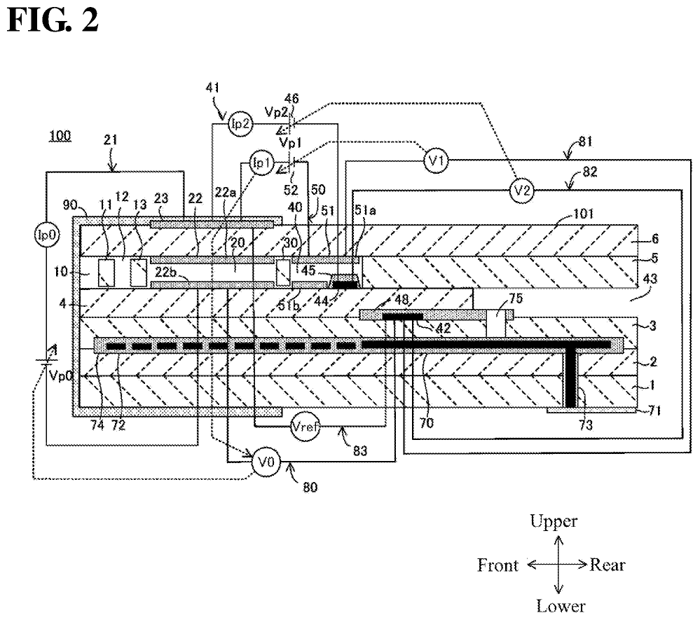

FIG. 2 is a cross-sectional schematic view schematically showing an example of the configuration of the sensor element 101 included in the gas sensor 100. The sensor element 101 is an element having a structure in which six layers consisting of a first substrate layer 1, a second substrate layer 2, a third substrate layer 3, a first solid electrolyte layer 4, a spacer layer 5, and a second solid electrolyte layer 6 are stacked in this order from the lower side in the drawing, the layers being each constituted by an oxygen ion-conductive solid electrolyte layer made of zirconia (ZrO₂) or the like. Furthermore, the solid electrolyte forming these six layers is a dense and airtight material. The sensor element 101 with this configuration is produced, for example, by performing predetermined processing and printing of circuit patterns on ceramic green sheets corresponding to the respective layers, stacking the resultant layers, and integrating them through firing.

The tip portion of the sensor element 101 is covered by a protective layer 90. The protective layer 90 is made of a porous material such as ceramic containing ceramic particles. Examples of the ceramic particles include particles of metallic oxide such as alumina (Al₂O₃), zirconia (ZrO₂), spinel (MgAl₂O₄), and mullite (Al₆O₁₃Si₂), and the protective layer 90 preferably contains at least any one of these materials. In this embodiment, the protective layer 90 is made of porous alumina.

In the front end of the sensor element 101, a gas introduction opening 10, a first diffusion control unit 11, a buffer space 12, a second diffusion control unit 13, a first internal cavity 20, a third diffusion control unit 30, and a second internal cavity 40 are arranged in this order adjacent to each other in a connected manner between the lower face of the second solid electrolyte layer 6 and the upper face of the first solid electrolyte layer 4.

The gas introduction opening 10, the buffer space 12, the first internal cavity 20, and the second internal cavity 40 are spaces inside the sensor element 101, the spaces being each formed by cutting out the spacer layer 5, and each having an upper portion defined by the lower face of the second solid electrolyte layer 6, a lower portion defined by the upper face of the first solid electrolyte layer 4, and side portions defined by the side faces of the spacer layer 5.

Each of the first diffusion control unit 11, the second diffusion control unit 13, and the third diffusion control unit 30 is provided as two laterally long slits (whose openings have the longitudinal direction that is along the direction perpendicular to the section of the diagram). Note that the region from the gas introduction opening 10 to the second internal cavity 40 is also referred to as a gas flow passage.

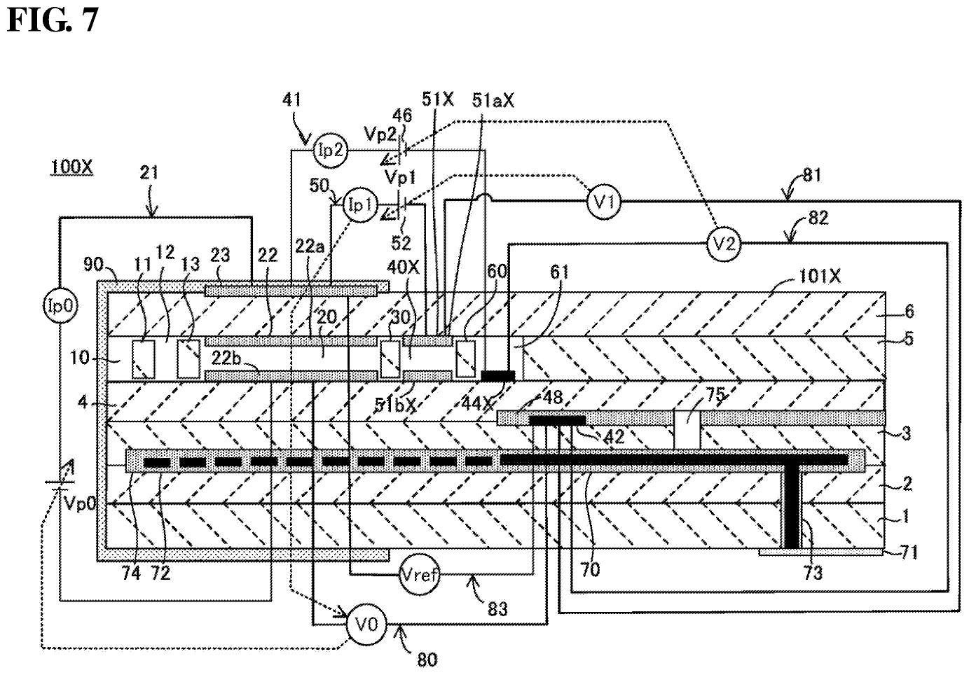

Furthermore, a reference gas introduction space 43 having side portions defined by the side faces of the first solid electrolyte layer 4 is provided between the upper face of the third substrate layer 3 and the lower face of the spacer layer 5, at a position that is farther from the front side than the gas flow passage is. For example, air is introduced into the reference gas introduction space 43. It is also possible that the first solid electrolyte layer 4 extends to the rear end of the sensor element 101, and the reference gas introduction space 43 is not formed. Furthermore, if the reference gas introduction space 43 is not formed, an air introduction layer 48 may extend to the rear end of the sensor element 101 (see FIG. 7, for example).

An air introduction layer 48 is a layer made of porous alumina, and reference gas is introduced into the air introduction layer 48 via the reference gas introduction space 43. Furthermore, the air introduction layer 48 is formed so as to cover a reference electrode 42.

The reference electrode 42 is an electrode formed so as to be held between the upper face of the third substrate layer 3 and the first solid electrolyte layer 4, and, as described above, is covered by the air introduction layer 48 that is continuous with the reference gas introduction space 43. Furthermore, as will be described later, it is possible to measure the oxygen concentration (oxygen partial pressure) in the first internal cavity 20 or the second internal cavity 40, using the reference electrode 42.

In the gas flow passage, the gas introduction opening 10 is a region that is open to the external space, and measurement target gas is introduced from the external space via the gas introduction opening 10 into the sensor element 101.

The first diffusion control unit 11 is a region that applies a predetermined diffusion resistance to the measurement target gas introduced from the gas introduction opening 10.

The buffer space 12 is a space that is provided in order to guide the measurement target gas introduced from the first diffusion control unit 11 to the second diffusion control unit 13.

The second diffusion control unit 13 is a region that applies a predetermined diffusion resistance to the measurement target gas introduced from the buffer space 12 into the first internal cavity 20.

When the measurement target gas is introduced from the outside of the sensor element 101 into the first internal cavity 20, the measurement target gas abruptly introduced from the gas introduction opening 10 into the sensor element 101 due to a change in the pressure of the measurement target gas in the external space (a pulsation of the exhaust pressure in the case in which the measurement target gas is exhaust gas of an automobile) is not directly introduced into the first internal cavity 20, but is introduced into the first internal cavity 20 after passing through the first diffusion control unit 11, the buffer space 12, and the second diffusion control unit 13 where a change in the concentration of the measurement target gas is canceled. Accordingly, a change in the concentration of the measurement target gas introduced into the first internal cavity is reduced to be almost negligible.

The first internal cavity 20 is provided as a space for adjusting the oxygen partial pressure in the measurement target gas introduced via the second diffusion control unit 13. The oxygen partial pressure is adjusted through an operation of a main pump cell 21.

The main pump cell 21 is an electro-chemical pump cell constituted by an internal pump electrode 22 having a ceiling electrode portion 22a provided over substantially the entire lower face of the second solid electrolyte layer 6 that faces the first internal cavity 20, an external pump electrode 23 provided so as to be exposed to the external space in the region corresponding to the ceiling electrode portion 22a on the upper face of the second solid electrolyte layer 6, and the second solid electrolyte layer 6 held between these electrodes.

The internal pump electrode 22 is formed across upper and lower solid electrolyte layers (the second solid electrolyte layer 6 and the first solid electrolyte layer 4) that define the first internal cavity 20, and the spacer layer 5 that forms side walls. Specifically, the ceiling electrode portion 22a is formed on the lower face of the second solid electrolyte layer 6 that forms the ceiling face of the first internal cavity 20, a bottom electrode portion 22b is formed on the upper face of the first solid electrolyte layer 4 that forms the bottom face. Side electrode portions (not shown) that connect the ceiling electrode portion 22a and the bottom electrode portion 22b are formed on side wall faces (inner faces) of the spacer layer 5 that form two side wall portions of the first internal cavity 20. That is to say, the internal pump electrode 22 is arranged in the form of a tunnel at the region in which the side electrode portions are arranged.

The internal pump electrode 22 and the external pump electrode 23 are formed as porous cermet electrodes (e.g., cermet electrodes of Pt and ZrO₂ containing 1% of Au). Note that the internal pump electrode 22 with which the measurement target gas is brought into contact is made of a material that has a lowered capability of reducing an NOx component in the measurement target gas.

The main pump cell 21 can apply a desired pump voltage Vp0 to a point between the internal pump electrode 22 and the external pump electrode 23, thereby causing a pump current Ip0 to flow in the positive direction or the negative direction between the internal pump electrode 22 and the external pump electrode 23, so that oxygen in the first internal cavity 20 is pumped out to the external space or oxygen in the external space is pumped into the first internal cavity 20.

Furthermore, in order to detect the oxygen concentration (oxygen partial pressure) in the atmosphere in the first internal cavity 20, the internal pump electrode 22, the second solid electrolyte layer 6, the spacer layer 5, the first solid electrolyte layer 4, the third substrate layer 3, and the reference electrode 42 constitute a main pump-controlling oxygen partial pressure detection sensor cell 80 (i.e., an electro-chemical sensor cell).

It is possible to specify the oxygen concentration (oxygen partial pressure) in the first internal cavity 20 by measuring an electromotive force V0 in the main pump-controlling oxygen partial pressure detection sensor cell 80. Furthermore, the pump current Ip0 is controlled by performing feedback control on Vp0 such that the electromotive force V0 is kept constant. Accordingly, the oxygen concentration in the first internal cavity 20 can be kept at a predetermined constant value.

The third diffusion control unit 30 is a region that applies a predetermined diffusion resistance to the measurement target gas whose oxygen concentration (oxygen partial pressure) has been controlled through an operation of the main pump cell 21 in the first internal cavity 20, thereby guiding the measurement target gas to the second internal cavity 40.

The second internal cavity 40 is provided as a space for performing processing regarding measurement of the concentration of nitrogen oxide (NOx) in the measurement target gas introduced via the third diffusion control unit 30. The NOx concentration is measured mainly in the second internal cavity 40 whose oxygen concentration has been adjusted by an auxiliary pump cell 50, through an operation of a measurement pump cell 41.

In the second internal cavity 40, the measurement target gas subjected to adjustment of the oxygen concentration (oxygen partial pressure) in advance in the first internal cavity 20 and then introduced via the third diffusion control unit is further subjected to adjustment of the oxygen partial pressure by the auxiliary pump cell 50. Accordingly, the oxygen concentration in the second internal cavity 40 can be precisely kept at a constant value, and thus the gas sensor 100 can measure the NOx concentration with a high level of precision.

The auxiliary pump cell 50 is an auxiliary electro-chemical pump cell constituted by an auxiliary pump electrode 51 having a ceiling electrode portion 51a provided on substantially the entire lower face of the second solid electrolyte layer 6 that faces the second internal cavity 40, the external pump electrode 23 (which is not limited to the external pump electrode 23, and may be any appropriate electrode outside the sensor element 101), and the second solid electrolyte layer 6.

The auxiliary pump electrode 51 with this configuration is arranged inside the second internal cavity 40 in the form of a tunnel as with the above-described internal pump electrode 22 arranged inside the first internal cavity 20. That is to say, the ceiling electrode portion 51a is formed on the second solid electrolyte layer 6 that forms the ceiling face of the second internal cavity 40, and a bottom electrode portion 51b is formed on the first solid electrolyte layer 4 that forms the bottom face of the second internal cavity 40. Side electrode portions (not shown) that connect the ceiling electrode portion 51a and the bottom electrode portion 51b are formed on two wall faces of the spacer layer 5 that form side walls of the second internal cavity 40. That is to say, the auxiliary pump electrode 51 is arranged in the form of a tunnel at the region in which the side electrode portions are arranged.

Note that the auxiliary pump electrode 51 is also made of a material that has a lowered capability of reducing an NOx component in the measurement target gas, as with the internal pump electrode 22.

The auxiliary pump cell 50 can apply a desired voltage Vp1 to a point between the auxiliary pump electrode 51 and the external pump electrode 23, so that oxygen in the atmosphere in the second internal cavity 40 is pumped out to the external space or oxygen in the external space is pumped into the second internal cavity 40.

Furthermore, in order to control the oxygen partial pressure in the atmosphere in the second internal cavity 40, the auxiliary pump electrode 51, the reference electrode 42, the second solid electrolyte layer 6, the spacer layer 5, the first solid electrolyte layer 4, and the third substrate layer 3 constitute an electro-chemical sensor cell, that is, an auxiliary pump-controlling oxygen partial pressure detection sensor cell 81.

Note that the auxiliary pump cell 50 performs pumping using a variable power source 52 whose voltage is controlled based on an electromotive force V1 detected by the auxiliary pump-controlling oxygen partial pressure detection sensor cell 81. Accordingly, the oxygen partial pressure in the atmosphere in the second internal cavity 40 is controlled to be a partial pressure that is low enough to not substantially affect the NOx measurement.

Furthermore, a pump current Ip1 is used to control the electromotive force of the main pump-controlling oxygen partial pressure detection sensor cell 80. Specifically, the pump current Ip1 is input as a control signal to the main pump-controlling oxygen partial pressure detection sensor cell 80, and the electromotive force V0 is controlled such that a gradient of the oxygen partial pressure in the measurement target gas that is introduced from the third diffusion control unit 30 into the second internal cavity 40 is always kept constant. When the sensor is used as an NOx sensor, the oxygen concentration in the second internal cavity 40 is kept at a constant value that is about 0.001 ppm through an operation of the main pump cell 21 and the auxiliary pump cell 50.

The measurement pump cell 41 measures the NOx concentration in the measurement target gas, in the second internal cavity 40. The measurement pump cell 41 is an electro-chemical pump cell constituted by a measurement electrode 44 spaced away from the third diffusion control unit 30, on the upper face of the first solid electrolyte layer 4 that faces the second internal cavity 40, the external pump electrode 23, the second solid electrolyte layer 6, the spacer layer 5, and the first solid electrolyte layer 4.

The measurement electrode 44 is a porous cermet electrode. The measurement electrode 44 functions also as an NOx reduction catalyst for reducing NOx that is present in the atmosphere in the second internal cavity 40. Furthermore, the measurement electrode 44 is covered by a fourth diffusion control unit 45.

The fourth diffusion control unit 45 is a membrane constituted by a porous member mainly made of alumina (Al₂O₃). The fourth diffusion control unit 45 serves to limit the amount of NOx flowing into the measurement electrode 44, and also functions as a protective membrane of the measurement electrode 44.

The measurement pump cell 41 can pump out oxygen generated through degradation of nitrogen oxide in the atmosphere around the measurement electrode 44, and detect the generated amount as a pump current Ip2.

Furthermore, in order to detect the oxygen partial pressure around the measurement electrode 44, the second solid electrolyte layer 6, the spacer layer 5, the first solid electrolyte layer 4, the third substrate layer 3, the measurement electrode 44, and the reference electrode 42 constitute an electro-chemical sensor cell, that is, a measurement pump-controlling oxygen partial pressure detection sensor cell 82. A variable power source 46 is controlled based on an electromotive force (a control voltage) V2 detected by the measurement pump-controlling oxygen partial pressure detection sensor cell 82.

The measurement target gas guided into the second internal cavity 40 passes through the fourth diffusion control unit 45 and reaches the measurement electrode 44 in a state in which the oxygen partial pressure is controlled. Nitrogen oxide in the measurement target gas around the measurement electrode 44 is reduced to generate oxygen (2NO→N₂+O₂). The generated oxygen is pumped by the measurement pump cell 41, and, at that time, a voltage Vp2 of the variable power source is controlled such that an electromotive force (a control voltage) V2 detected by the measurement pump-controlling oxygen partial pressure detection sensor cell 82 is kept constant. The amount of oxygen generated around the measurement electrode 44 is proportional to the concentration of nitrogen oxide in the measurement target gas, and thus it is possible to calculate the concentration of nitrogen oxide in the measurement target gas, using the pump current Ip2 in the measurement pump cell 41.

Furthermore, if the measurement electrode 44, the first solid electrolyte layer 4, the third substrate layer 3, and the reference electrode 42 are combined to constitute an oxygen partial pressure detection means as an electro-chemical sensor cell, it is possible to detect an electromotive force that corresponds to a difference between the amount of oxygen generated through reduction of an NOx component in the atmosphere around the measurement electrode 44 and the amount of oxygen contained in reference air can be detected, and thus it is also possible to obtain the concentration of the NOx component in the measurement target gas.

Furthermore, the second solid electrolyte layer 6, the spacer layer 5, the first solid electrolyte layer 4, the third substrate layer 3, the external pump electrode 23, and the reference electrode 42 constitute an electro-chemical sensor cell 83, and it is possible to detect the oxygen partial pressure in the measurement target gas outside the sensor, based on an electromotive force Vref obtained by the sensor cell 83.

In the gas sensor 100 with this configuration, when the main pump cell 21 and the auxiliary pump cell 50 operate, the measurement target gas whose oxygen partial pressure is always kept at a constant low value (a value that does not substantially affect the NOx measurement) is supplied to the measurement pump cell 41. Accordingly, it is possible to see the NOx concentration in the measurement target gas, based on the pump current Ip2 that flows when oxygen generated through reduction of NOx is pumped out by the measurement pump cell 41, substantially in proportion to the concentration of NOx in the measurement target gas.

Furthermore, in order to improve the oxygen ion conductivity of the solid electrolyte, the sensor element 101 includes a heater unit 70 that serves to adjust the temperature of the sensor element 101 through heating and heat retention. The heater unit 70 includes a heater electrode 71, a heater 72, a through-hole 73, a heater insulating layer 74, and a pressure dispersing hole 75.

The heater electrode 71 is an electrode formed so as to be in contact with the lower face of the first substrate layer 1. When the heater electrode 71 is connected to an external power source, electricity can be supplied from the outside to the heater unit 70.

The heater 72 is an electrical resistor formed so as to be held between the second substrate layer 2 and the third substrate layer 3 from above and below. The heater 72 is connected via the through-hole 73 to the heater electrode 71, and, when electricity is supplied from the outside via the heater electrode 71, the heater 72 generates heat, thereby heating and keeping the temperature of a solid electrolyte constituting the sensor element 101.

Furthermore, the heater 72 is embedded over the entire region from the first internal cavity 20 to the second internal cavity 40, and thus the entire sensor element 101 can be adjusted to a temperature at which the above-described solid electrolyte is activated.

The heater insulating layer 74 is an insulating layer constituted by an insulating member made of alumina or the like on the upper and lower faces of the heater 72. The heater insulating layer 74 is formed in order to realize the electrical insulation between the second substrate layer 2 and the heater 72 and the electrical insulation between the third substrate layer 3 and the heater 72.

The pressure dispersing hole 75 is a hole that extends through the third substrate layer 3 and is connected to the reference gas introduction space 43, and is formed in order to alleviate an increase in the internal pressure in accordance with an increase in the temperature in the heater insulating layer 74.

### 3. Configuration of Housing

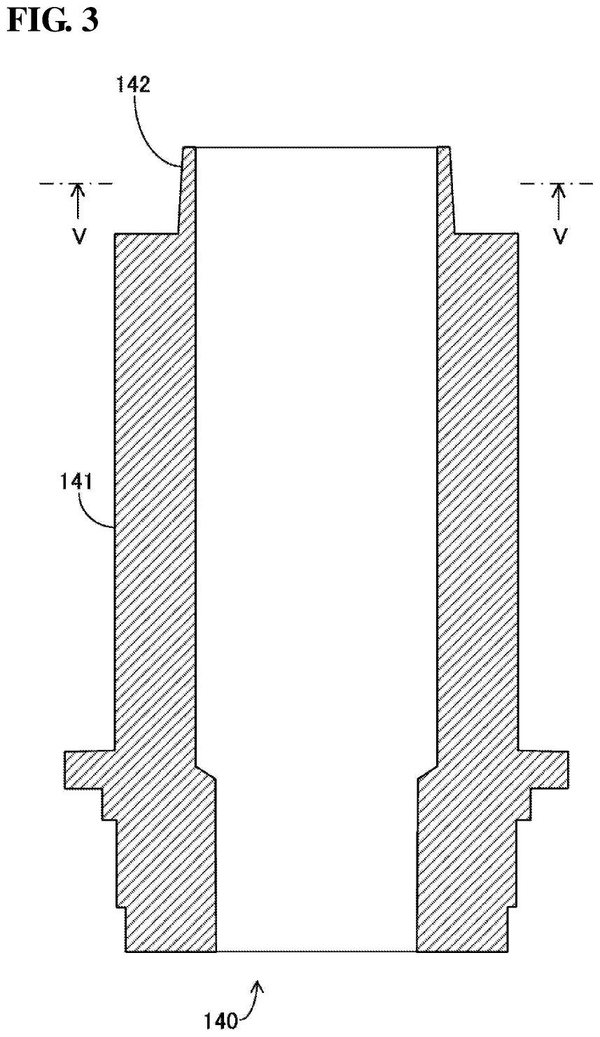

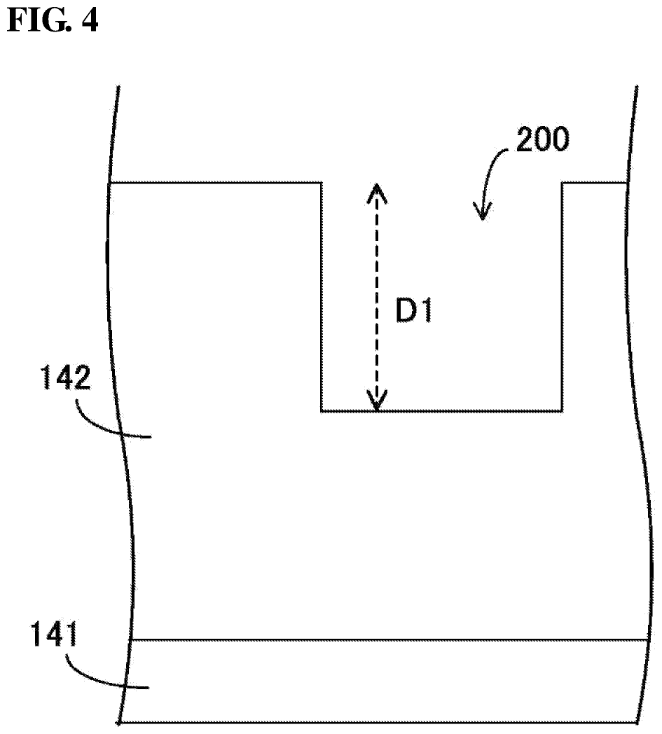

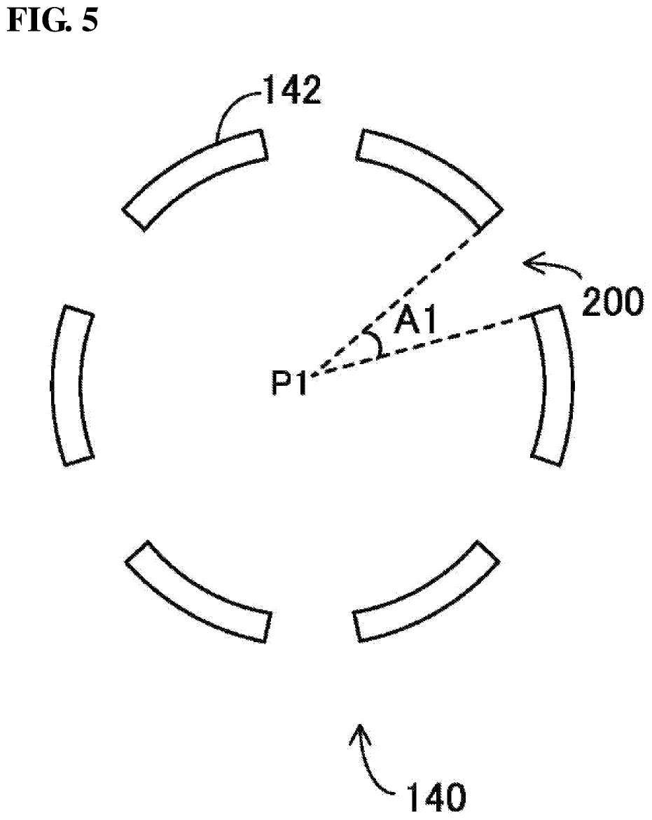

FIG. 3 is a view schematically showing a vertical cross-section of the housing 140 before the crimp portion 142 is crimped. FIG. 4 is a view schematically showing a state of part of the crimp portion 142 as viewed from a side. FIG. 5 is a view schematically showing a cross-section taken along V-V in FIG. 3.

Referring to FIGS. 3, 4, and 5, the crimp portion 142 further extends to the rear from the rear end of the main body 141. The plate thickness of the crimp portion 142 is smaller than that of the main body 141, and is, for example, 0.45 mm or more and 0.65 mm or less and, for example, approximately 0.56 mm.

Cutouts 200 are formed at predetermined intervals in the circumferential direction of the crimp portion 142. Each cutout 200 is formed by partially cutting away the crimp portion 142 from the ring-shaped rear end thereof toward the front side. A depth D1 (FIG. 4) of each cutout 200 is, for example, 2.00 mm or more and 3.00 mm or less, and is, for example, approximately 2.55 mm. The depth D1 of each cutout 200 is a length from a position corresponding to the rear end of the crimp portion 142 to the bottom of the cutout 200.

In this embodiment, six cutouts 200 are formed in the crimp portion 142. An angle A1 (FIG. 5) formed by a center P1 of a virtual circle and cutouts 200 when the crimp portion 142 is viewed from the rear side is, for example, 18° or more. In this case, the angle accounted for by the cutouts 200 in the entire crimp portion 142 (360°) is 108° or more. That is to say, the proportion of the length of the cutouts 200 in the crimp portion 142 with respect to the total length of the outer circumference of the crimp portion 142 is 0.3 or more. It is preferable that the angle A1 formed by the center P1 of the virtual circle and cutouts 200 when the crimp portion 142 is viewed from the rear side is 20° or more and 30° or less.

Hereinafter, the reason why a plurality of cutouts 200 are formed in the crimp portion 142 will be described. A case will be considered in which no cutout 200 is formed in the crimp portion 142. In this case, when the crimp portion 142 is crimped, the rear end of the crimp portion 142 is pushed inward in the radial direction, and thus the circumferential length of the rear end of the crimp portion 142 decreases. As a result, an excess part of the bent portion of the crimp portion 142 is forced outward in the radial direction, and thus, for example, lateral bulging of the crimp portion occurs. For example, when the crimp portion 142 is crimped by being pressed from the rear end, the occurrence of lateral bulging becomes more apparent. For example, there are cases in which the crimp portion 142 has to be pressed from the rear end due to manufacturing line conditions.

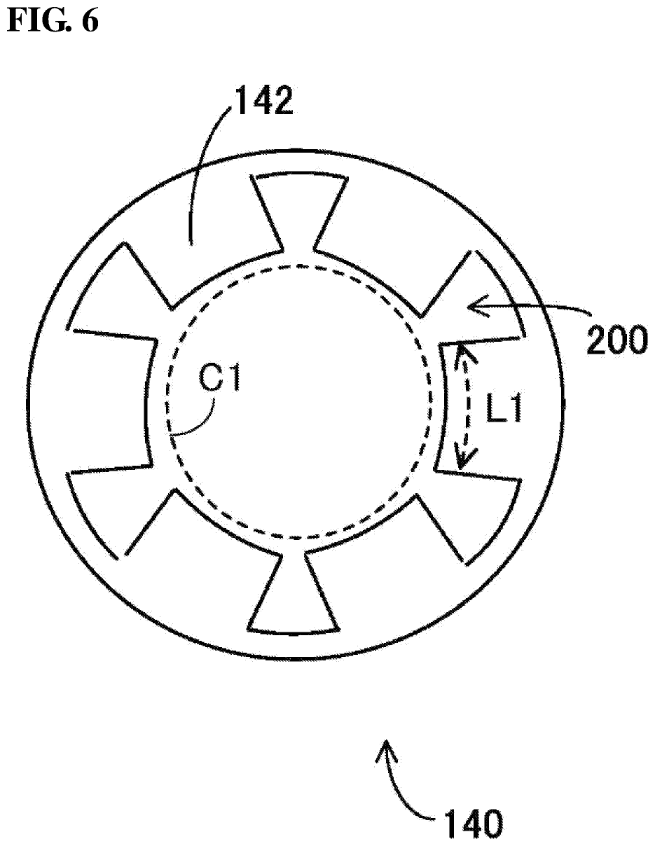

FIG. 6 is a schematic view showing a state in which the crimp portion 142 is crimped in the housing 140 of the gas sensor 100 according to this embodiment as viewed from the rear. Referring to FIG. 6, the cutouts 200 are formed in part of the crimp portion 142 in the circumferential direction. As a result, the total of circumferential lengths L1 of portions in which no cutout 200 is formed in the crimp portion 142 is smaller than, for example, the outer circumferential length of a virtual circle Cl surrounded by the rear end of the crimp portion 142 after crimping. Accordingly, even when the crimp portion 142 is crimped and the rear end of the crimp portion 142 is pushed inward in the radial direction, the bent portion is likely to be accommodated inside the radial direction. As a result, with the gas sensor 100 according to this embodiment, part of the crimp portion 142 is unlikely to be forced outward in the radial direction even when the crimp portion 142 is crimped from the rear, and thus lateral bulging of the crimp portion 142 is unlikely to occur.

### 4. Characteristics

As described above, in the gas sensor 100 according to this embodiment, the cutouts 200 are formed in part of the crimp portion 142 in the circumferential direction. Accordingly, even when the crimp portion 142 is crimped and the rear end of the crimp portion 142 is pushed inward in the radial direction, the bent portion is likely to be accommodated inside the radial direction compared with the case in which no cutout 200 is formed in the crimp portion 142. As a result, with the gas sensor 100, part of the crimp portion 142 is unlikely to be forced outward in the radial direction even when the crimp portion 142 is crimped, and thus lateral bulging of the crimp portion 142 is unlikely to occur.

### 5. Modified Examples

Although an embodiment of the present invention has been described above, the present invention is not limited to the foregoing embodiment, and various modifications can be made within the scope not departing from the gist of the invention. Hereinafter, modified examples will be described.

5-1

In the gas sensor 100 according to the foregoing embodiment, the first internal cavity 20 and the second internal cavity 40 are formed in the sensor element 101. That is to say, the sensor element 101 has a two-cavity structure. However, the sensor element 101 does not absolutely have to have a two-cavity structure. For example, it is also possible that the sensor element 101 has a three-cavity structure.

FIG. 7 is a cross-sectional schematic view schematically showing an example of the configuration of a sensor element 101X with a three-cavity structure. It is also possible that, as shown in FIG. 7, the second internal cavity 40 (FIG. 2) is further divided by a fifth diffusion control unit 60 into two cavities consisting of a second internal cavity 40X and a third internal cavity 61. In this case, an auxiliary pump electrode 51X may be arranged in the second internal cavity 40X, and a measurement electrode 44X may be arranged in the third internal cavity 61. In the case of applying a three-cavity structure, the fourth diffusion control unit 45 may be omitted.

5-2

In the gas sensor 100 according to the foregoing embodiment, six cutouts 200 are formed in the crimp portion 142. However, the number of cutouts 200 formed in the crimp portion 142 is not limited to six. For example, it is sufficient that the number of cutouts 200 formed in the crimp portion 142 is one or more.

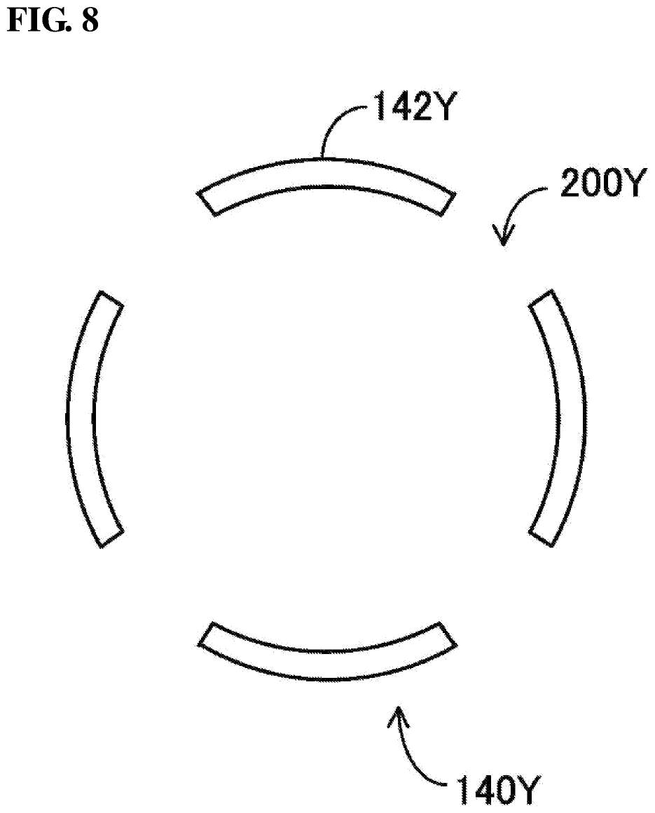

FIG. 8 is a view corresponding to FIG. 5 according to a modified example. As shown in FIG. 8, a housing 140Y has a crimp portion 142Y. Four cutouts 200Y are formed in the crimp portion 142Y. The shape of the crimp portion 142 may be this sort of shape.

### 6. Examples, Etc

### 6-1. Examples 1 to 4 and Comparative Example 1

An assembly (primary assembly) equivalent to part of the gas sensor 100 shown in FIG. 1 was manufactured. Examples 1 to 4 and Comparative Example 1 are different from each other only in terms of the shape of the crimp portion.

In Example 1, the number of cutouts formed in the crimp portion was four. The proportion of the length of the cutouts in the crimp portion with respect to the total length of the outer circumference of the crimp portion was ⅓. The depth (D1 in FIG. 4) of each cutout was 2.55 mm. The plate thickness of the crimp portion was 0.56 mm.

In Example 2, the number of cutouts formed in the crimp portion was six. The proportion of the length of the cutouts in the crimp portion with respect to the total length of the outer circumference of the crimp portion was ⅓. The depth of each cutout was 2.55 mm. The plate thickness of the crimp portion was 0.56 mm.

In Example 3, the number of cutouts formed in the crimp portion was four. The proportion of the length of the cutouts in the crimp portion with respect to the total length of the outer circumference of the crimp portion was ½. The depth of each cutout was 2.55 mm. The plate thickness of the crimp portion was 0.56 mm.

In Example 4, the number of cutouts formed in the crimp portion was six. The proportion of the length of the cutouts in the crimp portion with respect to the total length of the outer circumference of the crimp portion was ½. The depth of each cutout was 2.55 mm. The plate thickness of the crimp portion was 0.56 mm.

In Comparative Example 1, no cutout was formed in the crimp portion. The plate thickness of the crimp portion was 0.56 mm.

Table 1 below shows the characteristics of Examples 1 to 4 and Comparative Example 1.

TABLE 1

| | | Proportion of | | |
|---|---|---|---|---|
| | | cutout/outer | Depth of | Plate |
| | Number of | circumference | cutout | thickness |
| | cutouts | (%) | (mm) | (mm) |
| Ex. 1 | 4 | 1/3 | 2.55 | 0.56 |
| Ex. 2 | 6 | 1/3 | 2.55 | 0.56 |
| Ex. 3 | 4 | 1/2 | 2.55 | 0.56 |
| Ex. 4 | 6 | 1/2 | 2.55 | 0.56 |
| Com. Ex. 1 | — | — | — | 0.56 |

### 6-2. Test

### 6-2-1. Computed Tomography Scan of Crimp Portion

A primary assembly in each of Examples 1 to 4 and Comparative Example 1 was subjected to a computed tomography (CT) scan. Whether or not lateral bulging occurred in the crimp portion was checked based on an image obtained through the CT scan.

### 6-2-2. Leak Test

A leak test was performed using the primary assembly. The airtight performance between the holding member and the sensor element was tested through the leak test.

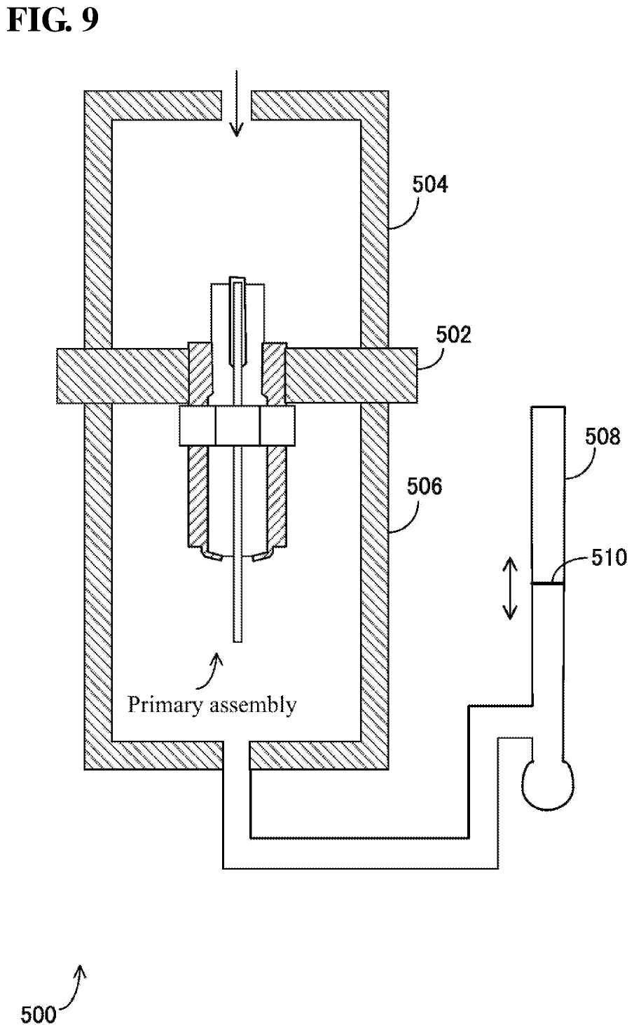

FIG. 9 is a schematic explanatory view of a leak test using a test tool 500. As shown in FIG. 9, the test tool 500 includes a mounting jig 502, an upper cover 504, a lower cover 506, and a tube 508. The mounting jig 502 has a female thread portion (not shown) in which a male thread portion (not shown) of the primary assembly can be mounted. The upper cover 504 and the lower cover 506 respectively cover the upper and lower portions of the mounting jig 502. The tube 508 is connected to the opening of the lower cover 506. The connecting portion of the upper cover 504, the mounting jig 502, and the lower cover 506 is sealed with an O-ring. A primary assembly with sealing tape wrapped around the female thread portion was mounted in the male thread portion of the mounting jig 502, and fixed with a torque wrench (4.0 Nm).

Accordingly, a state was obtained in which gas distribution does not occur between the inside of the upper cover 504 and the inside of the lower cover 506 except through the inside of the primary assembly. Then, a membrane 510 made of soap water was formed inside the tube 508. In this state, air was supplied from the upper opening of the upper cover 504 with application of a pressure at 0.4 MPaG for one minute, and the amount of rise (mm) of the membrane 510 was measured using a scale. This amount of rise was then converted into a leakage volume (cc/min). An amount of rise of 1 mm corresponds to a leakage volume of 0.01 cc (=0.01 cm³). The smaller the leakage volume, the higher the airtightness between the holding member 143 and the sensor element 101.

### 6-3. Test Results

### 6-3-1. Computed Tomography Scan of Crimp Portion

It was seen from the CT results that, in Examples 1 to 4, almost no buckling occurred at the crimp portion, and almost no lateral bulging of the crimp portion occurred either. Furthermore, the crimped shape was a straight shape. On the other hand, in Comparative Example 1, buckling occurred at the crimp portion, and lateral bulging of the crimp portion also occurred. Furthermore, the crimped shape was a curled shape.

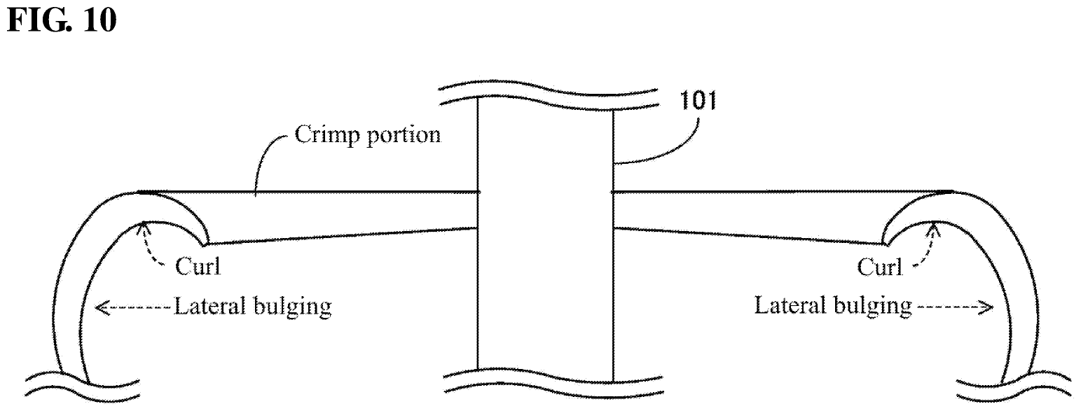

FIG. 10 is a view showing an example of the crimped shape according to Comparative Example 1. As shown in FIG. 10, in Comparative Example 1, lateral bulging occurred at the crimp portion. Furthermore, the bending point appeared near the rear end of the crimp portion, and the crimped shape was a curled shape.

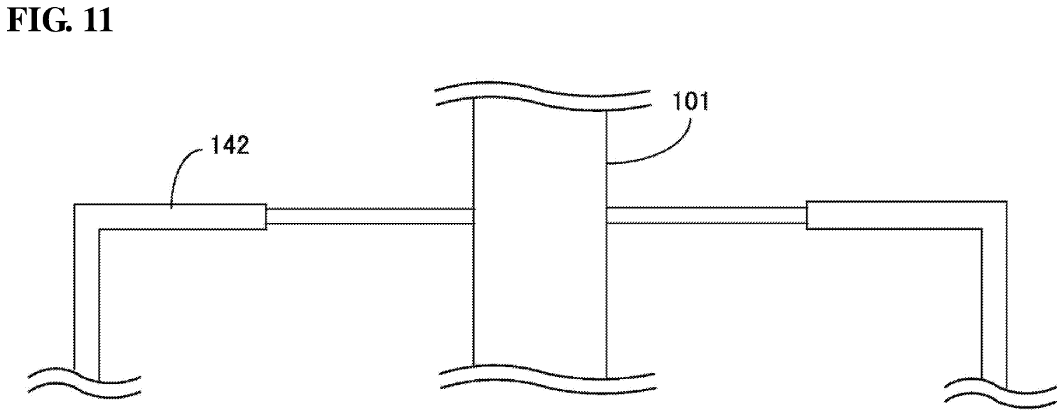

FIG. 11 is a view showing an example of the crimped shape according to Example 1. As shown in FIG. 11, in Example 1, lateral bulging did not occur at the crimp portion. The bending point appeared near the base of the crimp portion, and the crimped shape was a straight shape. In Examples 2 to 4 as well, lateral bulging of the crimp portion did not occur as in the case of Example 1.

### 6-3-2. Leak Test

Three primary assemblies were prepared for each of Examples 1 to 4 and Comparative Example 1, and were subjected to a leak test. Table 2 shows results of the leak test.

TABLE 2

| | Leakage volume [cc/min] |
|---|---|
| Ex. 1 | 0.042-0.056 |
| Ex. 2 | 0.037-0.061 |
| Ex. 3 | 0.033-0.042 |
| Ex. 4 | 0.028-0.047 |
| Com. Ex. 1 | 0.070-0.089 |

It was seen that the leakage volume in each of Examples 1 to 4 is smaller than that in Comparative Example 1.

### LIST OF REFERENCE NUMERALS

1 First substrate layer
2 Second substrate layer
3 Third substrate layer
4 First solid electrolyte layer
5 Spacer layer
6 Second solid electrolyte layer
10 Gas introduction opening
11 First diffusion control unit
12 Buffer space
13 Second diffusion control unit
20 First internal cavity
21 Main pump cell
22 Internal pump electrode
22a, 51a, 51aX Ceiling electrode portion
22b, 51b, 51bX Bottom electrode portion
23 External pump electrode
30 Third diffusion control unit
40, 40X Second internal cavity
41 Measurement pump cell
42 Reference electrode
43 Reference gas introduction space
44, 44X Measurement electrode
45 Fourth diffusion control unit
46, 52 Variable power source
48 Air introduction layer
50 Auxiliary pump cell
51, 51X Auxiliary pump electrode
60 Fifth diffusion control unit
61 Third internal cavity
70 Heater unit
71 Heater electrode
72 Heater
73 Through-hole
74 Heater insulating layer
75 Pressure dispersing hole
80 Main pump-controlling oxygen partial pressure detection sensor cell
81 Auxiliary pump-controlling oxygen partial pressure detection sensor cell
82 Measurement pump-controlling oxygen partial pressure detection sensor cell
83 Sensor cell
90 Protective layer
100 Gas sensor
101 Sensor element
130 Protective cover
140, 140Y Housing
141 Main body
142, 142Y Crimp portion
143 Holding member
144a, 144b Ceramic supporter
145 Green compact
200 Cutout
500 Test tool
502 Mounting jig
504 Upper cover
506 Lower cover
508 Tube
510 Membrane

What is claimed is:

1. A gas sensor comprising:
a sensor element configured to measure a concentration of a predetermined gas component in measurement target gas;
a holding member configured to hold part of the sensor element; and
a housing configured to accommodate the sensor element and the holding member,
wherein the housing includes:
a tubular main body; and
a tubular crimp portion that is located closer to a rear end than the main body is, and presses, in a bent state, a rear end of the holding member, and
a cutout is formed in part of the crimp portion in a circumferential direction.

2. The gas sensor according to claim 1, wherein a proportion of a length of the cutout in an outer circumference of the crimp portion with respect to a total length of the outer circumference of the crimp portion is 0.3 or more.

3. The gas sensor according to claim 1, wherein a proportion of a length of the cutout in an outer circumference of the crimp portion with respect to a total length of the outer circumference of the crimp portion is 0.25 or more and 0.45 or less.

4. The gas sensor according to claim 1, wherein the number of cutouts formed in the crimp portion is four or more and six or less.

5. The gas sensor according to claim 1, wherein a length from a position corresponding to a rear end of the crimp portion to a bottom of the cutout is 2.00 mm or more and 3.00 mm or less.

6. The gas sensor according to claim 1, wherein a plate thickness of the crimp portion is 0.45 mm or more and 0.65 mm or less.
